(19) United States
(12) Patent Application Publication
(10) Pub. No.: US 2017/0262625 A1
(43) Pub. Date: Sep. 14, 2017

(54) INFORMATION PROCESSING APPARATUS AND INFORMATION PROCESSING METHOD

(71) Applicant: Saeko TAKEDA, Kanagawa (JP)

(72) Inventor: Saeko TAKEDA, Kanagawa (JP)

(73) Assignee: Ricoh Company, Ltd., Tokyo (JP)

(21) Appl. No.: 15/444,815

(22) Filed: Feb. 28, 2017

(30) Foreign Application Priority Data
Mar. 14, 2016 (JP) 2016-049493

(51) Int. Cl. G06F 21/40; G06F 21/31

(52) U.S. Cl. CPC G06F 21/40; G06F 21/31

(57) ABSTRACT

An information processing apparatus is provided that includes a processor configured to execute one or more programs to implement an authentication unit that performs an authentication process with respect to identification information based on a first program, an activation unit that communicates the identification information to a second program, which is distinct from the first program, while the authentication process is being performed based on the first program, and requests for activation of the second program, and a determination unit that receives a response from the second program and determines whether to restrict use of the information processing apparatus based on the response from the second program.

### CROSS-REFERENCE TO RELATED APPLICATIONS

The present application claims priority under 35 U.S.C. §119 to Japanese Patent Application No. 2016-049493 filed on Mar. 14, 2016, the entire contents of which are incorporated herein by reference.

### BACKGROUND OF THE INVENTION

1. Field of the Invention

The present invention relates to an information processing apparatus and an information processing method.

2. Description of the Related Art

Various types of devices are equipped with an authentication function for restricting use of the device to authorized users. For example, a login screen may be displayed on a display unit of a device, and a user may be allowed to use the device after a correct user ID and password are input to the login screen.

### SUMMARY OF THE INVENTION

According to one embodiment of the present invention, an information processing apparatus is provided that includes a processor configured to execute one or more programs to implement an activation unit that performs an authentication process with respect to identification information based on a first program, an activation unit that communicates the identification information input by the user to a second program, which is distinct from the first program, while the authentication process is being performed based on the first program and requests for activation of the second program, and a determination unit that receives a response from the second program and determines whether to restrict use of the information processing apparatus based on the response from the second program.

### BRIEF DESCRIPTION OF THE DRAWINGS

FIG. 1 is a diagram illustrating an example configuration of an information processing system according to a first embodiment of the present invention;

FIG. 2 is a diagram illustrating an example hardware configuration of an information processing terminal according to the first embodiment;

FIG. 3 is a diagram illustrating an example functional configuration implemented in the information processing terminal or an image forming apparatus;

FIG. 4 is a sequence chart illustrating an example process of setting up setting information for a login application;

FIG. 5 is a diagram illustrating an example selectable value list;

FIG. 6 is a sequence chart illustrating an example login process according to the first embodiment;

FIG. 7 is a diagram illustrating an example screen transition during the login process;

FIG. 8 is a sequence chart illustrating an example login process according to a second embodiment of the present embodiment.

### DESCRIPTION OF THE EMBODIMENTS

To improve customizability of a device, measures may be desired for enabling the device to execute a process other than an authentication process while the authentication process is being performed.

However, rewriting a program for performing an authentication process for each client is quite burdensome for a developer. In such a case, source code for the program for each client has to be maintained.

An aspect of the present invention is directed to reducing the work load for configuring a user authentication process to be interrupted by another process.

In the following, embodiments of the present invention are described with reference to the accompanying drawings.

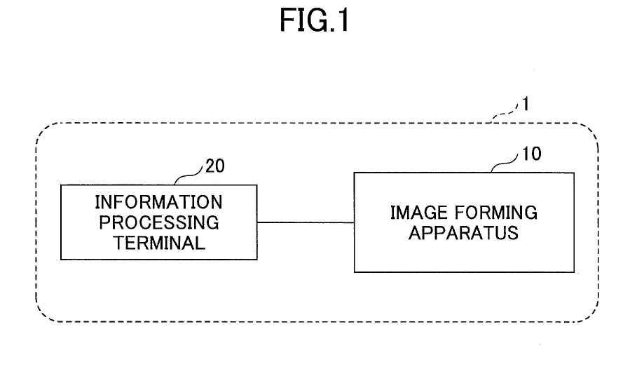

FIG. 1 is a diagram illustrating an example configuration of an information processing system 1 according to a first embodiment of the present invention. In FIG. 1, the information processing system 1 includes an image forming apparatus 10 and an information processing terminal 20 that are connected so that they can communicate with each other. Note that communication between the image forming apparatus 10 and the information processing terminal 20 is may be established using USB (Universal Serial Bus), short-range wireless communication, or a network such as a LAN (wired or wireless), for example.

The image forming apparatus 10 may be a multifunction peripheral (MFP) that implements two or more functions, such as printing, scanning, copying, and/or facsimile transmission, for example. However, the image forming apparatus 10 may also be a device having any one of the above functions, for example. Further, according to some embodiments, a device such as a projector, a video conference system, a digital camera, or the like may be used instead of the image forming apparatus 10, for example.

The information processing terminal 20 may be a smartphone, a tablet terminal, or some other type of electronic device that is capable of executing complete information processing on its own, for example. In the present embodiment, the information processing terminal 20 functions as an operation unit of the image forming apparatus 10. More specifically, the information processing terminal 20 is connected to the image forming apparatus 10 in place of an operation panel that is typically installed as a dedicated operation unit of an image forming apparatus.

For example, the information processing terminal 20 may be installed at a predetermined position (e.g., a position where an operation panel is typically installed) of the image forming apparatus 10. As such, the information processing terminal 20 and the image forming apparatus 10 may be regarded as a single apparatus. Alternatively, the information processing terminal 20 may be detachable from the image forming apparatus 10. When the information processing terminal 20 is detached from the image forming apparatus 10, the information processing terminal 20 may be capable of functioning as an operation unit of the image forming apparatus 10 through wireless communication using Bluetooth (registered trademark) or infrared wireless technology, for example.

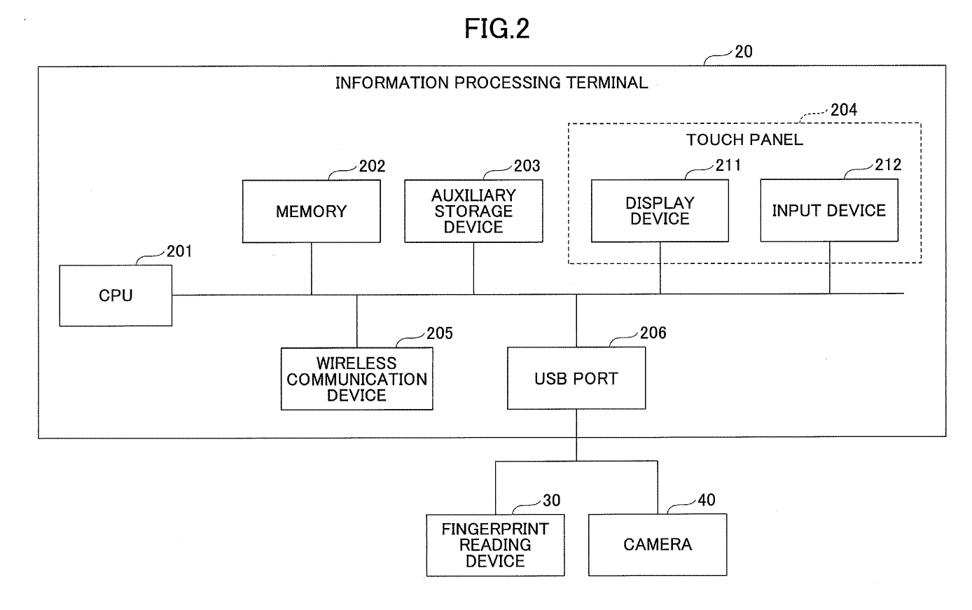

FIG. 2 is a diagram illustrating an example hardware configuration of the information processing terminal 20 according to the first embodiment. In FIG. 2, the information processing terminal 20 includes a CPU 201, a memory 202, an auxiliary storage device 203, a touch panel 204, a wireless communication device 205, and a USB (Universal Serial Bus) port 206.

The auxiliary storage device 203 stores programs installed in the information processing terminal 20, for example. When an instruction to activate a program is issued, the program is read from the auxiliary storage device 203 and loaded in the memory 202 so that it can be executed. The CPU 201 implements functions of the information processing terminal 20 based on the program stored in the memory 202.

The touch panel 204 is an electronic component having both an input function and a display function. The touch panel 204 displays information and accepts an input from a user, for example. The touch panel 204 includes a display device 211 and an input device 212.

The display device 211 may be a liquid crystal display, for example, and implements the display function of the touch panel 204. The input device 212 is an electronic component including a sensor for detecting contact of an object with the display device 211. The method used for detecting contact of the object may be any known method, such as an electrostatic method, a resistive film method, or an optical method, for example. Note that the object detected by the input device 212 may be any object that comes into contact with a contact surface (surface) of the touch panel 204. For example, such an object may be a finger of the user, a dedicated pen, or a regular pen.

The wireless communication device 205 includes an electronic component, such as an antenna, for establishing communication in a wireless LAN (Local Area Network) or a mobile communication network, for example.

The USB port 206 may include one or more USB ports. That is, the information processing terminal 20 may include a plurality of USB ports. In the present embodiment, a fingerprint reading device 30 and a camera 40 are connected to the USB port 206 via a USB cable as example external input devices for inputting unique information of a user. The fingerprint reading device 30 is a device for reading fingerprint information of a user using the image forming apparatus 10. The camera 40 is a digital camera. The camera 40 may be installed so that it can capture an image of the face of the user of the image forming apparatus 10, for example. Note that these external input devices may be removed or replaced with other external input devices for inputting other types of information according to settings for user authentication, for example.

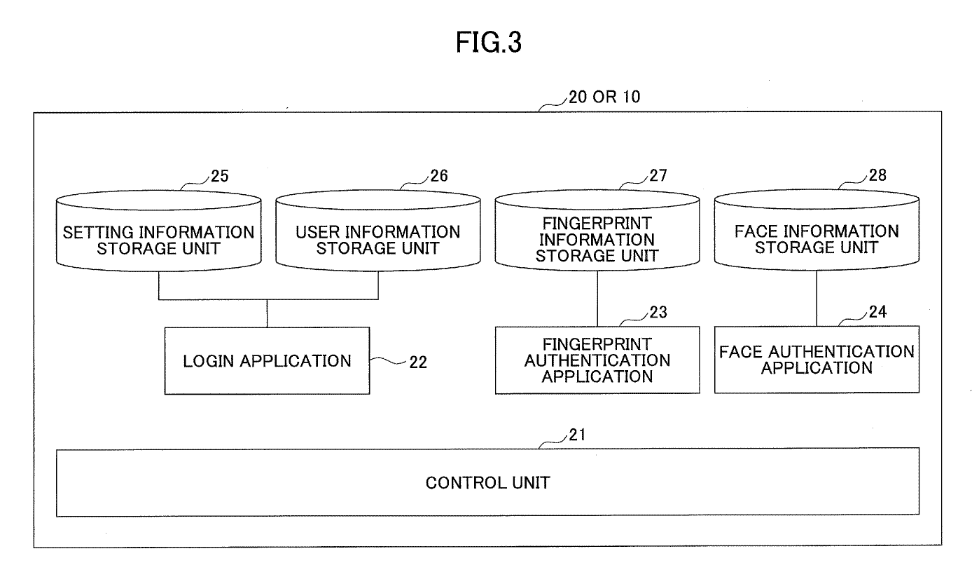

FIG. 3 is a diagram illustrating an example functional configuration that may be implemented in the information processing terminal 20 or the image forming apparatus 10. According to the first embodiment, the functional configuration of FIG. 3 is implemented in the information processing terminal 20. That is, the information processing terminal 20 includes a control unit 21, a login application 22, a fingerprint authentication application 23, and a face authentication application 24. These functional units may be implemented by process operations executed by the CPU 201 based on one or more programs installed in the information processing terminal 20, for example. The information processing terminal 20 also includes a setting information storage unit 25, a user information storage unit 26, a fingerprint information storage unit 27, and a face information storage unit 28. These storage units may be implemented by the auxiliary storage device 203 of FIG. 2 or some other storage device that is connected to the information processing terminal 20 via a network, for example.

The control unit 21 controls the operation of the information processing terminal 20. The login application 22 is an application program for executing an authentication process with respect to a user using the image forming apparatus 10 in order to prevent information leakage and reduce misprints, for example. The authentication process is a process of identifying a user that wishes to use the image forming apparatus 10 from among registered users. In the present embodiment, the user is identified based on a user ID and a password. The user information storage unit 26 stores user IDs and passwords of registered users. Upon successful identification of the user (successful login), the user may be allowed to use the image forming apparatus 10. On the other hand, if login is not successful, the user is prevented from using a part or all of the functions of the image forming apparatus 10. Note that the information processing terminal 20 maintains information indicating whether one of the registered users is logged in or whether no one is logged in, for example. The login application 22 is activated when no one is logged in.

The fingerprint authentication application 23 is an application program for reading fingerprint information from the fingerprint reading device 30 and performing verification. The fingerprint information is information indicating the features of a fingerprint and is an example of information unique to the user. The fingerprint authentication application 23 has an interface for accepting an activation request with a user ID as an argument. Upon receiving the activation request, the fingerprint authentication application 23 displays a screen prompting the user to input fingerprint information to the fingerprint reading device 30. The fingerprint authentication application 23 periodically accesses the fingerprint reading device 30 to monitor input of fingerprint information by the user, and when the fingerprint information is read by the fingerprint reading device 30, the fingerprint authentication application 23 acquires the fingerprint information. The fingerprint authentication application 23 determines whether a combination of the acquired fingerprint information and the user ID in the accepted activation request is stored in the fingerprint information storage unit 27 and returns the determination result to the activation request source. Further, the fingerprint authentication application 23 may have a function of newly registering a combination of a user ID and fingerprint information in the fingerprint information storage unit 27. Note that in a case where the fingerprint information storage unit 27 provided in an external device (e.g., authentication server), the fingerprint authentication application 23 may request the external device to determine whether the combination of the acquired fingerprint information and the user ID in the accepted activation request is stored in the fingerprint information storage unit 27, for example.

The face authentication application 24 is an application program for acquiring a face image of a user captured by the camera 40 and performing verification. The face image is image data capturing the face of the user and is an example of information unique to the user. Like the fingerprint authentication application 23, the face authentication application 24 also has an interface for accepting an activation request with the user ID as an argument. Upon accepting the activation request, the face authentication application 24 displays a screen prompting the user to input a face image by facing the camera 40. The face authentication application 24 displays the face image captured by the camera 40 and determines whether a combination of feature information of the face image and the user ID in the accepted activation request is stored in the face information storage unit 28. The face authentication application 24 then returns the determination result to the activation request source. Further, the face authentication application 24 may have a function of newly registering a combination of a user ID and feature information of a face image in the face information storage unit 28. Note that in a case where the face information storage unit 28 is provided in an external device (e.g., authentication server), the face authentication application 24 may request the external device to determine whether the combination of the captured face image and the user ID is stored in the face information storage unit 28, for example.

The control unit 21 may include a USB host function, for example. The fingerprint authentication application 23 and the face authentication application 24 may access the fingerprint reading device 30 and the camera 40 via the USB host function, for example.

In the present embodiment, the login application 22 is installed in the information processing terminal 20 as an application program that executes a predetermined authentication process. On the other hand, the fingerprint authentication application 23 and the face authentication application 24 may be installed in the information processing terminal 20 as necessary or desired. That is, the fingerprint authentication application 23 and the face authentication application 24 are examples of an “additional authentication application” that can be additionally installed in the information processing terminal 20 as necessary or desired. The additional authentication application is an application program for executing a process related to the authentication process of the present embodiment. Each additional authentication application may be associated with a corresponding external input device. Note that the additional authentication application performs verification of input information but does not determine whether to restrict use of the image forming apparatus 10 by a user. Such a determination is made by the login application 22.

The setting information storage unit 25 stores, as setting information for the login application 22, information indicating an application program to be used as an additional authentication application.

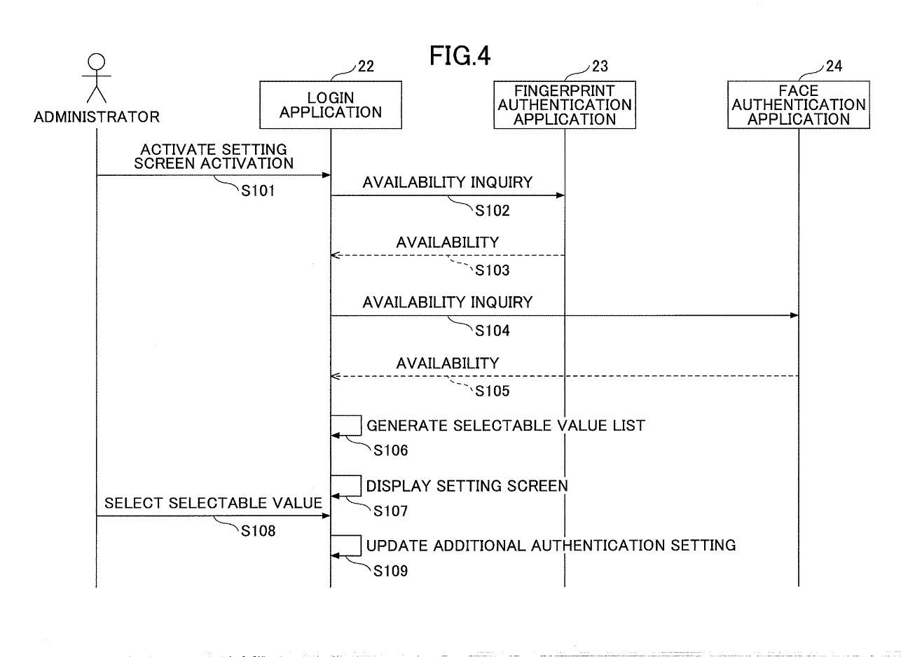

In the following, process operations executed by the information processing terminal 20 are described. FIG. 4 is a sequence chart illustrating an example process of setting up setting information for the login application 22.

For example, when an administrator of the image forming apparatus 10 selects a predetermined icon displayed on the information processing terminal 20 to activate a setting screen of the login application 22 (step S101), the login application 22 sends an inquiry to each additional authentication application regarding its availability via an availability acquisition interface of each additional authentication application (steps S102, S104). The availability acquisition interface is an interface (e.g., method) implemented in each additional authentication application for responding to an availability inquiry for the corresponding additional authentication application.

For example, the auxiliary storage device 203 of the information processing terminal 20 may store list information of additional authentication applications installed in the information processing terminal 20. The login application 22 may refer to the list information to identify the additional authentication application to which an availability inquiry is to be transmitted.

In response to the availability inquiry received via the availability acquisition interface, each additional authentication application checks the connection status of its corresponding external input device and sends a response to the login application 22 including information indicating its availability (steps S103, S105). That is, the fingerprint authentication application 23 checks the connection status of the fingerprint reading device 30. The face authentication application 24 checks the connection status of the camera 40. Each additional authentication application sends a response indicating that the additional authentication application can be used if its corresponding external input device is connected to the information processing terminal 20, but otherwise sends a response indicating that the additional authentication application cannot be used (i.e., if the corresponding external input device is not connected).

Then, the login application 22 generates a selectable value list based on the response from each additional authentication application (step S106).

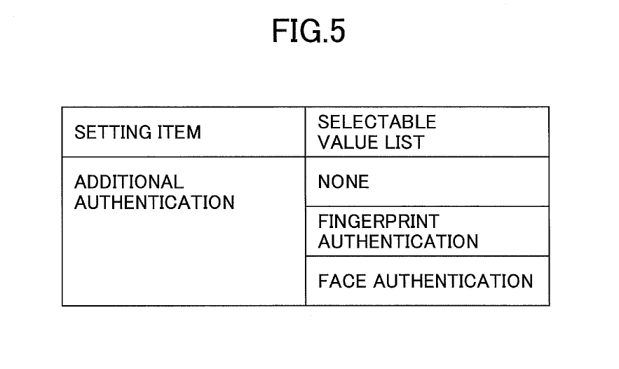

FIG. 5 is a diagram illustrating an example of the selectable value list. FIG. 5 illustrates an example where selectable values for the setting item “additional authentication” include “none”, “fingerprint authentication”, and “face authentication”. The value “none” is an option to be selected when no additional authentication application is to be used. The value “fingerprint authentication” is an option to be selected when the fingerprint authentication application 23 is to be used. The value “face authentication” is an option to be selected when the face authentication application 24 is to be used. Note that FIG. 5 illustrates an example selectable value list that is displayed when both the fingerprint authentication application 23 and the face authentication application 24 can be used. Note that if the fingerprint authentication application 23 cannot be used, for example, the value “fingerprint authentication” will not be included in the selectable value list. That is, the login application 22 generates the selectable value list to include the value “none” and a value corresponding to the additional authentication application that can be used.

Then, the login application 22 displays a setting screen including the generated selectable value list on the display device 211 (step S107).

Then, when one of the options in the selectable value list is selected by the administrator via the setting screen (step S108), the login application 22 updates the setting value for the setting item “additional authentication” stored in the setting information storage unit 25 by setting up the value corresponding to the selected option (step S109). Note that when the option other than “none” is selected, a plurality of the selectable value options may be selected. Also, note that in some embodiments, only a user having specific authorization, such as an administrator, may be allowed to operate the setting screen, for example.

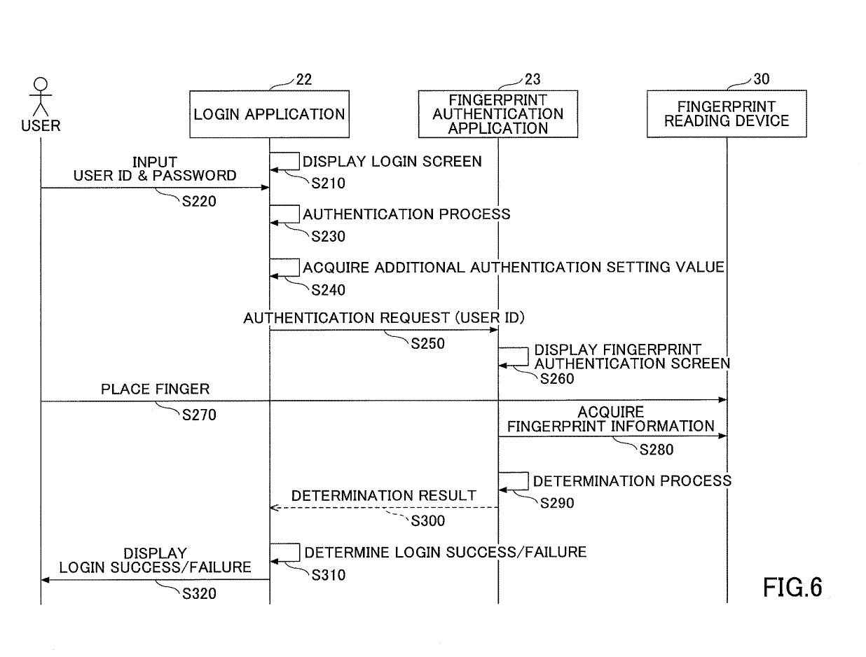

FIG. 6 is a sequence chart illustrating an example login process according to the first embodiment.

The login application 22 displays a login screen on the display device 211 when no one is logged in (step S210).

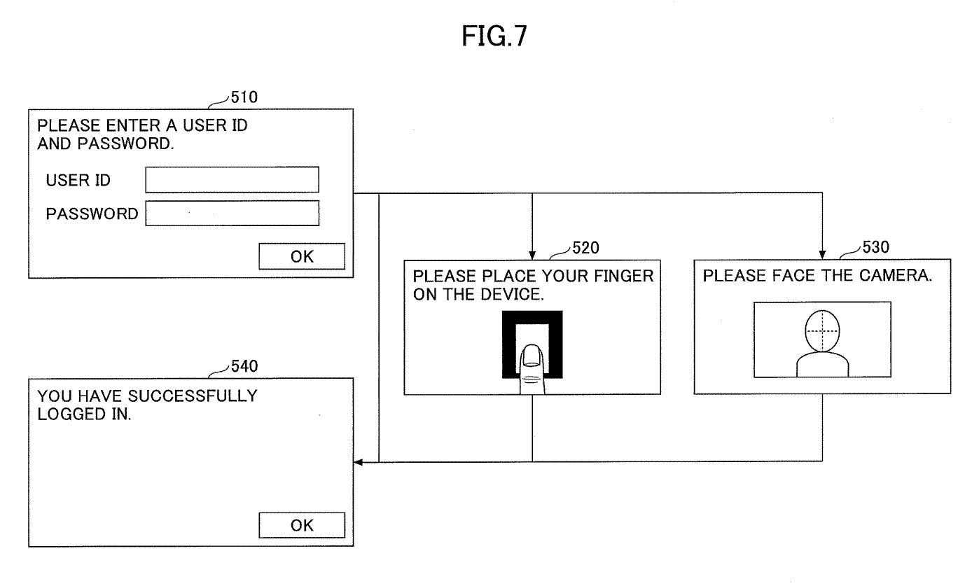

FIG. 7 is a diagram illustrating an example screen transition during the login process. In FIG. 7, a login screen 510 is displayed for prompting input of a user ID and a password.

When the user inputs a user ID and a password (step S220), the login application 22 executes an authentication process on the input user ID and password (step S230). For example, the login application 22 determines whether the input combination of user ID and password is stored in the user information storage unit 26. If the combination of user ID and password is not stored in the user information storage unit 26, the login process ends in failure. In this case, the subsequent process steps are not executed, and the user is restricted from using the image forming apparatus 10.

When the input combination of user ID and password is stored in the user information storage unit 26, the login application 22 acquires the setting value for the setting item “additional authentication” from the setting information storage unit 25 (step S240). In the present example, it is assumed that “fingerprint authentication” is stored as the setting value in the setting information storage unit 25. In this case, the login application 22 activates a thread or process of the fingerprint authentication application 23 as a part of the authentication process (step S250). At this time, the input user ID is communicated to the fingerprint authentication application 23.

Upon being activated, the fingerprint authentication application 23 displays a fingerprint authentication screen 520 (FIG. 7) on the display device 211 (step S260). As a result, the screen being displayed is switched from the login screen 510 to the fingerprint authentication screen 520. As illustrated in FIG. 7, the fingerprint authentication screen 520 is a screen prompting the user to input fingerprint information.

When the user places a finger on the fingerprint reading device 30 (step S270), the fingerprint authentication application 23 acquires fingerprint information read by the fingerprint reading device 30 (step S280). Then, the fingerprint authentication application 23 determines whether a combination of the acquired fingerprint information and the user ID received from the login application 22 is stored in the fingerprint information storage unit 27 (step S290). Then, the fingerprint authentication application 23 returns the determination result to the login application 22 (step S300). After returning the determination result, the thread or process of the fingerprint authentication application 23 may be terminated.

Based on the determination result from the finger print authentication application 23, the login application 22 determines whether login is successful (step S310). For example, if the determination result from the finger print authentication application 23 indicates that the combination of fingerprint information and user ID is stored in the fingerprint information storage unit 27, the login application 22 determines that login is successful (use restriction is unnecessary). If the determination result from the finger print authentication application 23 indicates that the combination of fingerprint information and user ID is not stored in the fingerprint information storage unit 27, the login application 22 determines that login is unsuccessful (use restriction is necessary).

Then, the login application 22 displays a login result screen 540 (FIG. 7) indicating whether login is successful on the display device 211 (step S320). The login result screen 540 of FIG. 7 illustrates an example where login is successful.

If the login is successful, the login application 22 notifies the control unit 21 of the login success. As a result, the control unit 21 lifts the use restriction that has been implemented while no one has been logged in. In this way, the user may be allowed to use the functions of the image forming apparatus 10 within the authorization range of the user.

Note that in the case where “face authentication” is set up as the setting value for the setting item “additional authentication”, the face authentication application 24 is activated instead of the fingerprint authentication application 23. In this case, a face authentication screen 530 as illustrated in FIG. 7 may be displayed on the display device 211. The face authentication screen 530 is a screen for prompting the user to input a face image.

As described above, according to an aspect of the first embodiment, while an authentication process of the login application 22 is being executed, the authentication process may be interrupted by a process of an additional authentication application, which is an application program distinct from the login application 22. The interruption of the authentication process by another process may be implemented without modifying the login application 22. As a result, development man-hours for configuring the authentication process to be interrupted by a new process may be reduced. That is, the work load for enabling another process to interrupt a user authentication process may be reduced. For example, even when a new external input device has to be added, a corresponding additional authentication application may be provided to handle the external input device, for example.

The additional authentication application may also be called by application programs other than the login application 22, and as such, reusability of the additional authentication program may be enhanced. Also, the additional authentication application may be used by a plurality of application programs installed in the information processing terminal 20.

Also, in order to enhance security, a plurality of additional authentication applications may be used, for example.

Also, in the above-described embodiment, the additional authentication application verifies input information and returns the verification result to the application that has called the additional authentication application. However, in other embodiments, the additional authentication application may only be configured to acquire the input information without performing the verification process, for example. In this case, the additional authentication application may return the acquired input information to the application program corresponding to the call source, for example.

Further, the application program called by the login application 22 is not limited to an application program for verifying unique information of the user (i.e., additional authentication information). For example, a time period during which each user is allowed to use the image forming apparatus 10 may be stored in association with a corresponding user ID, and an application program may be called that is configured to return a response indicating whether the current time is within the time period associated with the user ID that has been accepted by the login application 22 and passed on to this application program. Other various application programs may also be called by the login application 22. That is, a process that is to interrupt the authentication process is not limited to a particular process.

In the following, a second embodiment of the present invention is described. Note that descriptions of features of the second embodiment that may be substantially identical to those of the first embodiment may be omitted below. That is, the following descriptions mainly relate to features of the second embodiment that differ from those of the first embodiment.

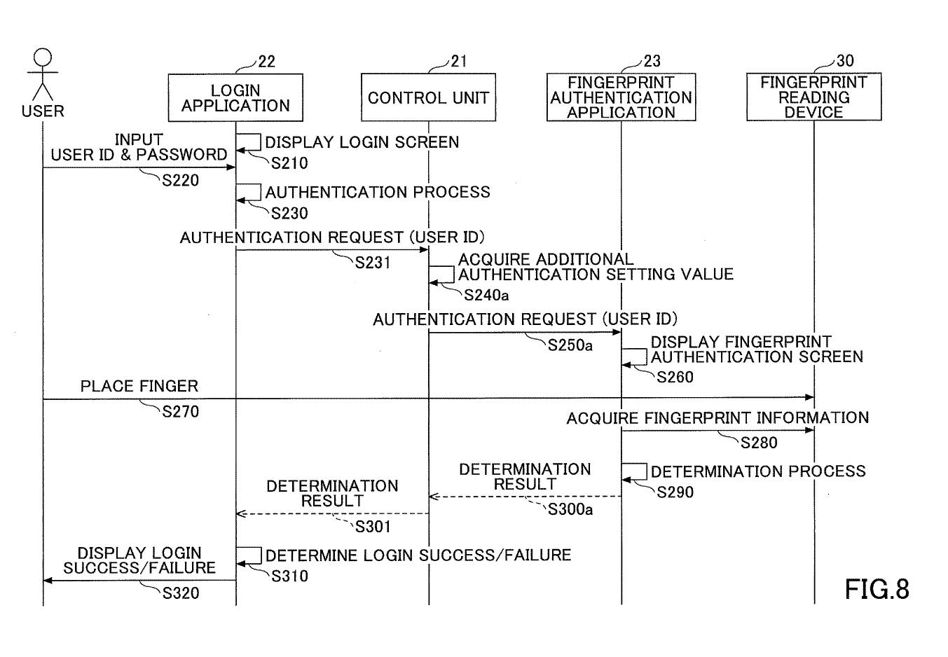

FIG. 8 is a sequence chart illustrating an example login process according to the second embodiment. In FIG. 8, process steps that are substantially identical to those of FIG. 6 are given the same reference numerals and their descriptions may be omitted. In the second embodiment, process steps of determining the additional authentication application to be called and calling the additional authentication application are implemented by the control unit 21.

Specifically, the control unit 21 includes an interface for accepting an additional authentication request. The login application 22 inputs an additional authentication request including the input user ID to the control unit 21 via such an interface (step S231).

In response to the additional authentication request from the login application 22, the control unit 21 executes a process identical to the process of step S240 of FIG. 6 to identify the additional authentication application to be called (step S240a). In the present example, as in FIG. 4, it is assumed that the fingerprint authentication application 23 is identified as the additional authentication application to be called. Thus, the control unit 21 activates the thread or process of the fingerprint authentication application 23 (step S250a). At this time, the input user ID is communicated to the fingerprint authentication application 23.

Then, the fingerprint authentication application 23 determines whether the combination of the acquired fingerprint information and the user ID received from the control unit 21 is stored in the fingerprint information storage unit 27 (step S290) and returns the determination result to the control unit 21 (step S300a). The control unit 21 then transmits the determination result to the login application 22 (step S301).

Note that in the second embodiment, the control unit 21 may execute the process steps of FIG. 4 that are executed by the login application 22 in the first embodiment.

Also, in some embodiments, when the login application 22 executes the process steps of FIG. 4 as in the first embodiment, the login application 22 may execute the process of step S240 of FIG. 6 and thereafter notify the control unit 21 of the additional authentication application to be activated, for example.

Also, in some embodiments, the login application 22 may request the control unit 21 to activate a fixed additional authentication application or an additional authentication application determined based on conditions other than the setting value stored in the setting information storage unit 25, for example.

As described above, according to an aspect of the second embodiment, the control unit 21 may execute the processes of activating the additional authentication application. In this way, the amount of interaction between the login application 22 and the additional authentication application may be reduced. As a result, an impact on the login application 22 due to a change in the interface of the additional authentication application may be reduced, for example.

Note that the processes described above that are executed by the information processing terminal 20 may alternatively be executed by the image forming apparatus 10, for example. That is, in some embodiments, the image forming apparatus 10 may implement the functional configuration illustrated in FIG. 3.

Also, note that the information processing terminal 20 and the image forming apparatus 10 described above are examples of an information processing apparatus. The login application 22 is an example of a first program. The additional authentication application is an example of a second program. The user ID is an example of identification information.

Also, note that although biometric authentication such as face authentication and fingerprint authentication are described as example functions implemented by the second program in the above-described embodiments, other types of biometric authentication or authentication other than biometric authentication may also be used in embodiments of the present invention.

Although the present invention has been described above with reference to certain illustrative embodiments, the present invention is not limited to these embodiments, and numerous variations and modifications may be made without departing from the scope of the present invention.

Note that a person skilled in the field of information processing technology may implement the present invention using an application specific integrated circuit (ASIC) or an apparatus in which circuit modules are connected.

Further, each of the functions (units) described in connection with the above embodiments may be implemented by one or more circuits.

The one or more circuits described above may include a processor programmed by software to execute a corresponding function, and/or hardware, such as an ASIC or a circuit module, designed to execute a corresponding function, for example.

What is claimed is:

1. An information processing apparatus comprising:
a processor configured to execute one or more programs to implement
an authentication unit that performs an authentication process with respect to identification information based on a first program;
an activation unit that communicates the identification information to a second program, which is distinct from the first program, while the authentication process is being performed based on the first program, and requests for activation of the second program; and
a determination unit that receives a response from the second program and determines whether to restrict use of the information processing apparatus based on the response from the second program.

2. The information processing apparatus according to claim 1, wherein
an external input device configured to accept an input of unique information of a user can be connected to the information processing apparatus; and
the activation unit requests for activation of the second program that is associated with the external input device upon determining that the external input device associated with the second program is connected to the information processing apparatus.

3. The information processing apparatus according to claim 2, wherein
the activation unit requests for activation of the second program that is selected from among the second programs associated with the external input device that is connected to the information processing apparatus.

4. The information processing apparatus according to claim 2, wherein
the second program causes the information processing apparatus to execute a process of determining whether the unique information of the user input to the external input device is stored in a storage unit.

5. The information processing apparatus according to claim 1, wherein
the activation unit requests for activation of the second program upon determining that the identification information has been successfully authenticated by the authentication process.

6. An information processing method that is implemented by an information processing apparatus, the information processing method comprising steps of:
performing an authentication process with respect to identification information input by a user based on a first program;
communicating the identification information input by the user to a second program, which is distinct from the first program, and requesting for activation of the second program while the authentication process is being performed based on the first program; and
receiving a response from the second program and determining whether to restrict use of the information processing apparatus by the user based on the response from the second program.

7. The information processing method according to claim 6, wherein
an external input device configured to accept an input of unique information of the user can be connected to the information processing apparatus; and
the request for activation is made with respect to the second program that is associated with the external input device upon determining that the external input device associated with the second program is connected to the information processing apparatus.

8. The information processing method according to claim 7, wherein
the request for activation is made with respect to the second program that is selected by the user from among the second program associated with the external input device that is connected to the information processing apparatus.

9. The information processing method according to claim 7, wherein
the second program causes the information processing apparatus to execute a process of determining whether the unique information of the user input to the external input device is stored in a storage unit.

10. The information processing method according to claim 6, wherein
the request for activation of the second program is made upon determining that the identification information input by the user has been successfully authenticated by the authentication process.

11. A computer program product comprising a non-transitory computer-readable medium having a first program and a second program recorded thereon that are executable by an information processing apparatus, the first program when executed causing the information processing apparatus to implement processes of:
performing an authentication process with respect to identification information input by a user;
communicating the identification information input by the user to the second program, which is distinct from the first program, and requesting for activation of the second program while the authentication process is being performed; and
receiving a response from the second program and determining whether to restrict use of the information processing apparatus by the user based on the response from the second program.

12. The computer program product according to claim 11, wherein
an external input device configured to accept an input of unique information of the user can be connected to the information processing apparatus; and
the request for activation is made with respect to the second program that is associated with the external input device upon determining that the external input device associated with the second program is connected to the information processing apparatus.

13. The computer program product according to claim 12, wherein
the request for activation is made with respect to the second program that is selected by the user from among the second program associated with the external input device that is connected to the information processing apparatus.

14. The computer program product according to claim 12, wherein
the second program causes the information processing apparatus to execute a process of determining whether the unique information of the user input to the external input device is stored in a storage unit.

15. The computer program product according to claim 11, wherein
the request for activation of the second program is made upon determining that the identification information input by the user has been successfully authenticated by the authentication process.
